(19) United States
(12) Patent Application Publication
(10) Pub. No.: US 2008/0263007 A1
(43) Pub. Date: Oct. 23, 2008

(54) MANAGING ARCHIVED DATA

(75) Inventor: Olaf Schmidt, Walldorf (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/738,351

(22) Filed: Apr. 20, 2007

(51) Int. Cl. G06F 17/00; G06F 17/30

(52) U.S. Cl. 707/3; 707/204; 707/E17.005

(57) ABSTRACT

This disclosure provides various embodiments of systems, methods, and software for managing archived data. For example, software for archiving data may receive a request to archive an unstructured data object and archive the unstructured data object into an archive object in an offline storage media. The archive object is associated with one or more metadata attributes. The request may be received from an exposed API method embedded within a communicably coupled business application. The software may receive identification of an archive index via the request from the exposed API, where the archive index points to the offline storage media and is based on one or more metadata attribute criteria. The software may parse the archive object into the metadata attributes according to at least a subset of the attribute criteria and populate the archive index with the one or more metadata attributes indexing the archive object.

### TECHNICAL FIELD

This disclosure relates to managing data and, more particularly, to systems, methods, and software for implementing, utilizing, or otherwise managing archived data through a generic framework.

### BACKGROUND

Businesses often generate and utilize large amounts of data during their operation and management. Often, this data may be contained in documents, e.g., spreadsheets, correspondence, invoices, purchase orders, or other business forms. Documents may only be used or needed for a finite duration of time, yet a business may not desire to discard the documents completely after they are no longer needed. In some cases, documents that are no longer needed for daily business decisions or management may be moved to an archives These documents are typically stored electronically in active (or other fast access) storage, such as a database, which allows the business application to search the documents using one or more pieces of information, often termed metadata. This metadata may be stored in an index in the database, such that a document may be quickly located. Removal of metadata during such archiving may prevent the business from quickly locating the document or searching the archived documents using the business application.

### SUMMARY

This disclosure provides various embodiments of systems, methods, and software for managing archived data. For example, in some embodiments, software for archiving data may receive a request to archive an unstructured data object and archive the unstructured data object into an archive object in an offline storage media, the archive object associated with one or more metadata attributes. In some aspects, the request may be received from an exposed application programming interface (API) method embedded within a communicably coupled business application. The software may also receive identification of an archive index via the request from the exposed API, where the archive index points to the offline storage media and is based on one or more metadata attribute criteria. The software may also parse the archive object into one or more metadata attributes according to at least a subset of the attribute criteria and populate the archive index with the one or more metadata attributes indexing the archive object. In certain aspects, the request may be an invoked generic method associated with an attribute table. In some aspects, the software may receive at least one attribute identifier from the requester, identify one or more metadata attributes based on the attribute table and the attribute identifier, and populate the archive index with the one or more metadata attributes indexing the archive object. The software may also present the table to a client for customization. The software may control access to the table based on an access permission level.

In certain aspects, the software may execute a generic archive process to archive the unstructured data object in the offline storage media, parse the archive object in the offline storage media into one or more metadata attributes, and populate a generic archive index with the one or more metadata attributes indexing the archive object, the generic archive index pointing to the offline storage media and based on one or more metadata attribute criteria. The software may, if the generic archive index does not exist, generate the generic archive index. Also, the software may execute a batch process that parses a plurality of archive objects in the offline storage media into one or more respective metadata attributes.

In some implementations, the software may also drop the unstructured data object from an online storage media. Also, one or more archive indices can include at least one metadata attribute and at least one index key utilizing one of the metadata attributes. The software may access the archive object in the offline storage media utilizing the index key. Further, the archive index may be stored in a disparate storage device from the offline storage media.

In certain embodiments, a computer-implemented method for managing archived data includes receiving a first query from a first application instance utilizing an application programming interface (API), based on the first query, asynchronously searching active data and archived data using an archive index that identifies at least a portion of metadata when the archived data was active, and presenting a first results interface to the first application that displays results as they are received from the query executions. The method may also include receiving a second query from a second application instance utilizing the API, based on the second query, asynchronously searching active data and archived data using an archive index, and presenting a second results interface to the second application that displays results as they are received from the query executions. In some aspects, the method may include presenting a search criteria interface to the first application, the search criteria interface comprising a plurality of search criteria and receiving at least one search criteria from the first application, the search criteria comprising one or more of a plurality of metadata attributes. The first and second queries may include at least one of the plurality of search criteria. Also, the one or more metadata attributes may correspond to the portion of metadata identified when the archived data was active.

Each of the foregoing, as well as other disclosed example methods, may be computer implementable. Moreover, some or all of these aspects may be further included in respective systems and software for managing archived data. The details of these and other aspects and embodiments of the disclosure are set forth in the accompanying drawings and the description below. Features, objects, and advantages of the various embodiments will be apparent from the description and drawings, and from the claims.

### DESCRIPTION OF DRAWINGS

FIG. 1 illustrates a database environment implementing or managing archived data in accordance with one embodiment of the present disclosure;

FIG. 2 illustrates a more detailed configuration of the database system of FIG. 1;

FIG. 3A illustrates an example of an archive framework in accordance with one implementation of FIG. 1;

FIG. 3B illustrates another example of an archive framework in accordance with one implementation of FIG. 1;

FIG. 4 illustrates an example client interface for customizing archive indices for use by the system of FIG. 1;

FIG. 5 illustrates an example client interface for customizing the searching of archived data using the system of FIG. 1;

FIG. 6 is a flowchart illustrating the addition of search criteria to a search of data, whether archived or active, through the client interface in FIG. 5;

FIG. 7 is a flowchart illustrating a search of archived data and active data in accordance with one embodiment of the present disclosure; and

FIG. 8 illustrates an example client interface for viewing the data located by the search of FIG. 7.

### DETAILED DESCRIPTION

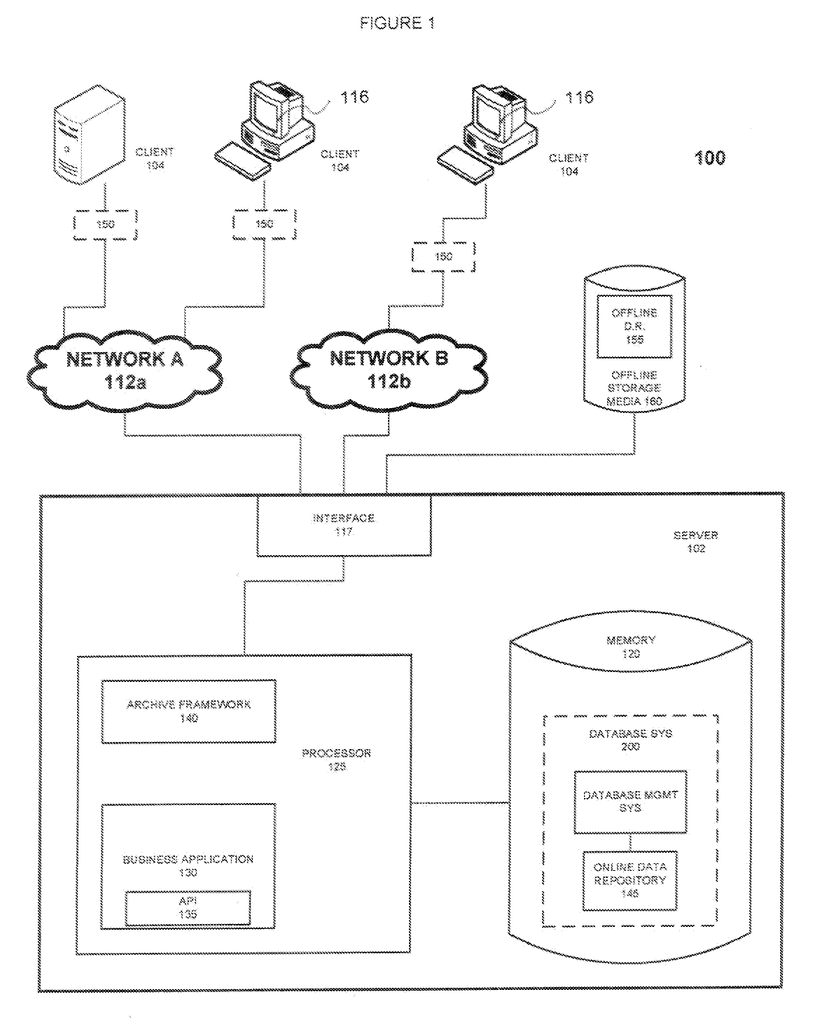

FIG. 1 illustrates a database environment 100 for implementing or managing archived data objects 240 in at least a portion of an enterprise or data processing environment. At a high level, database environment 100 may provide a mechanism or technique to archive one or more active data objects 230 to an offline data repository 155, while populating metadata attributes associated with the archived data objects 240 into one or more archive indices 220. In this fashion, archived objects 240 may be stored in less expensive media, yet be located or accessed more quickly using such archive indices 220. Such archival might reduce the load on active systems, such as databases, while still retaining metadata attributes in archived data objects 240. Database environment 100 may populate the archive indices 220 automatically during the archiving of active data objects 230 by utilizing an application programming interface (API) 135 method. Additionally, database environment 100 may populate metadata attributes into the archive indices 220 during the archiving of active data objects 230 through the identification of one or more metadata attributes associated with an attribute table 310. Further, database environment 100 may archive the active data objects 230 to the offline data repository 155 through a generic archive process 350, and subsequently, build the archive indices 220 through identified metadata attributes within the archived data objects 240. Moreover, database environment 100 may allow for the asynchronous searching of both active data objects 230 and archived data objects 240 based upon one or more metadata attributes associated with the data objects 230 and 240. The searching of the data objects 230 and 240 may be instigated through the receipt of a query from a business application 130 utilizing the API 135. In some situations, database environment 100 allows the migration of non-critical performance data, e.g., data that may not be used in daily business operations, to cheaper forms of storage media. Also, database environment 100 may allow the migration of online index data to an archive index in order to control the size of the online index. This can allow for better, e.g., faster responses to queries for online data used during daily business operations and management.

Environment 100 may be a distributed client/server system that allows clients 104 to submit requests to, for example, archive active data objects 230 from an online data repository 145 to an offline data repository 155 or, as another example, asynchronously search archive data objects 240 utilizing an archive index 220 and active data objects 230. In some cases, active data objects 230 may be unstructured data objects, for example, documents related to or pertinent to business records, such as invoices, bills, purchase orders, or correspondence. But environment 100 may also be a standalone computing environment or any other suitable environment, such as an administrator accessing data stored on server 102, without departing from the scope of this disclosure. Turning to the illustrated embodiment, database environment 100 includes server 102 coupled to one or more clients 104 through one or more networks 112. Server 102 includes interface 117, memory 120, and processor 125 and comprises an electronic computing device operable to receive, transmit, process, and store data associated with environment 100. For example, server 102 may be any computer or processing device such as a mainframe, a blade server, a general-purpose personal computer (PC), a Macintosh, a workstation, a Unix-based computer, or any other suitable device. Generally, FIG. 1 provides merely one example of computers that may be used with the disclosure. In other words, the present disclosure contemplates computers other than general purpose computers, as well as computers without conventional operating systems. As used in this document, the term “computer” is intended to encompass a personal computer, workstation, network computer, or any other suitable processing device. For example, although FIG. 1 illustrates one server 102 that may be used with this disclosure, environment 100 can be implemented using computers other than servers, as well as a server pool. Server 102 may be adapted to execute any operating system including z/OS, Linux-Intel or Linux/390, UNIX, Windows Server, or any other suitable operating system. According to one embodiment, server 102 may also include or be communicably coupled with a web server and/or an SMTP server. Server 102 can accept data from client 104 via a web browser (e.g., Microsoft Internet Explorer or Mozilla Firefox) and return the appropriate HTML or XML responses using network 112. For example, server 102 may receive such an SQL query from client 104 using the web browser and then execute the query to archive active data objects 230 into archived data objects 240 to be stored in offline data repository 155.

Server 102 includes memory 120, which may include any memory or database module and may take the form of volatile or non-volatile memory including, without limitation, magnetic media, optical media, random access memory (RAM), read-only memory (ROM), removable media, or any other suitable local or remote memory component. In this embodiment, illustrated memory 120 includes database system 200. Database system 200 includes a database management system and an online data repository 145. Generally, illustrated database system 200 is meant to represent a local or distributed database, warehouse, or other information repository that includes or utilizes various components.

Continuing with FIG. 1, the database management system is typically software that manages online data repository 145, performs tasks associated with database management, and/or responds to queries, including storing information in memory 120, searching online data repository 145, generating responses to queries using information in online data repository 145, and numerous other related tasks. For example, database management system 108 may be any database management software such as, for example, a relational database management system, a database management system using flat files or CSV files, an Oracle® database, a structured query language (SQL) database, and the like. As used herein, software generally includes any appropriate combination of software, firmware, hardware, and/or other logic. For example, the database management system, as well as archive framework 140 and business application 130, may be written or described in any appropriate computer language including, for example, C, C++, Java, Visual Basic, assembler, Perl, ABAP, any suitable version of 4GL, or any combination thereof. It will be understood that while database management system is illustrated in FIG. 1 as a single multi-tasked module, the features and functionality performed by this engine may be performed by multiple modules such as, for example, one or more agents or database instances. Further, while illustrated as internal to server 102, one or more processes associated with the database management system may be stored, referenced, or executed remotely. Moreover, database management system may be a child or sub-module of another software module (such as online data repository 145) without departing from the scope of this disclosure.

In more detail, online data repository 145 is coupled to and accessed, called, or otherwise managed by the database management system. Online data repository 145 may store one or more active data objects 230, as well as one or more active indices 210 and one or more archive indices 220. Generally, active data objects 230 may be unstructured data, e.g., documents or other attachments. However, in some aspects, active data objects 230 may be structured data, i.e., data in a relational format, thus allowing database environment 100 to provide access to such data in online data repository 145 using a structured query language (SQL).

Continuing with FIG. 1, database environment 100 may also include an offline storage media 160. Offline storage media 160 may take the form of an optical storage device, such as a CD-ROM or DVD, or may be a tape or other magnetic storage device, or any other appropriate device for the storage of electronic data. Although illustrated in FIG. 1 as separate from server 102 and communicably coupled through interface 117, offline storage media 160 may, in some cases, reside on client 104 or be communicably coupled to client 104. Further, in some cases, offline storage media 160 may be integral to server 102. Offline storage media 160 may, in some aspects, include offline data repository 155. Generally, offline data repository 155 may store archived data objects 240, as well as, in some cases, one or more archive indices 220.

Returning to the illustrated server 102, this server 102 includes processor 125, which executes instructions (such as the logic or software described above) and manipulates data to perform the operations of server 102 such as, for example, a central processing unit (CPU), a blade, an application specific integrated circuit (ASIC), or a field-programmable gate array (FPGA). In particular, processor 125 performs any suitable tasks associated with the database management system, business application 130, and archive framework 140. Although FIG. 1 illustrates a single processor 125 in server 102, multiple processors 125 may be used according to particular needs and reference to processor 125 is meant to include multiple processors 125, where applicable.

Processor 125 may include archive framework 140. Generally, archive framework 140 may facilitate the archival of one or more active data objects 230 into archived data objects 240 stored in offline data repository 155, in response to a request from client 104 to archive the active data objects 230. Archive framework 140 manages the archival of the active data objects 230 through various methods. For example, in some aspects, the request by client 104 is received from an API 135 method exposed by the archive framework 140. The archive framework 140 may expose the API 135 through one of several methods internal to the API 135 or through its own method. In this example, the request may also include the identification of one or more archived indices 220. As another example, in some cases, the archive framework 140 may facilitate the archival request from the client 140 through a generic method, i.e., non-API method, associated with attribute customization table 310. As yet another example, in some aspects, the archive framework 140 may execute a generic archival process in order to archive one or more active data objects 230 to archived data objects 240 in offline data repository 155.

Processor 125 includes business application 130, which, in certain embodiments, may request access to retrieve, modify, delete, or otherwise manage the information of one or more database systems 200 in memory 120, as well as any data contained in the offline storage media 160. Business application 130 may be considered a business software or solution that is capable of interacting or integrating with database systems 200 located, for example, in memory 120 to provide access to data for personal or business use. An example business application 130 may be a computer application for performing any suitable business process or logic by implementing or executing a plurality of steps. Business application 130 may also provide the user, such as an administrator, with computer implementable techniques that may result in the management of archived data objects 240. More specifically, business application 130 may facilitate or help facilitate the functionality of the archive framework 140 and API 135.

More specifically, business application 130 may be a composite application, or an application built on other applications, that includes an object access layer (OAL) and a service layer. In this example, application 130 may execute or provide a number of application services such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help composite application 130 to orchestrate a business process in synchronization with other existing processes (e.g., native processes of enterprise base systems) and leverage existing investments in the IT platform. Further, composite application 130 may run on a heterogeneous IT platform. In doing so, composite application 130 may be cross-functional in that it may drive business processes across different applications, technologies, and organizations. Accordingly, composite application 130 may drive end-to-end business processes across heterogeneous systems or sub-systems. Application 130 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes the composite application 130, it may instead be a standalone or (relatively) simple software program. Regardless, application 130 may also perform processing automatically, which may indicate that the appropriate processing is substantially performed by at least one component of system 100. It should be understood that this disclosure further contemplates any suitable administrator or other user interaction with application 130 or other components of environment 100, without departing from its original scope.

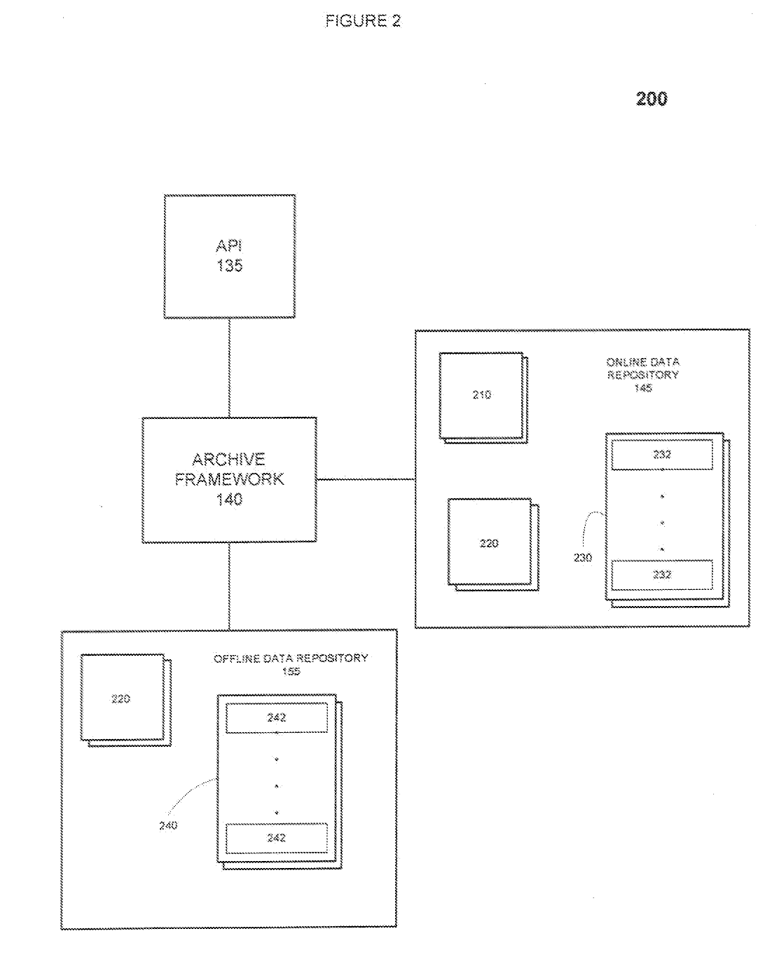

API 135 may be embedded in business application 130, as shown, for example, in FIG. 1. In some cases, API 135 may reside on one or more clients 104. Generally, in some aspects, the API 135 may be accessed by client 104, e.g., a developer at client 104, in order for the client 104 to send a query 150 to business application 130 to request the archival of one or more active data objects 230 stored in online data repository 145. The archival of active data objects 230 may proceed by several methods, as explained in more detail below. In some aspects, a request to archive active data objects 230 may be from an exposed API 135 method, which identifies one or more archive indices 220 to populate with metadata attributes during the archival process, explained in more detail in FIG. 2.

API 135 may also facilitate the querying of archived data objects 240 and active data objects 230 based on one or more identified metadata attribute criteria. The query may be performed asynchronously, e.g., the search for particular archived data objects 240 may occur separate from and distinct to the search for active data objects 230. The results of the query of archived data objects 240 and active data objects 230 may be presented to client 104 through GUI 116 in a seamless, scrolling (i.e., expanding) window.

Server 102 may also include interface 117 for communicating with other computer systems, such as client 104, over network 112 in a client-server or other distributed environment. In certain embodiments, server 102 receives queries 150, for example, requests for data access or archival of active data objects 230 from local or remote senders, through interface 117, for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

Database environment 100 also may include network 112, which facilitates wireless or wireline communication between server 102 and any other local or remote computer, such as clients 104. Indeed, while illustrated as two networks, 112a and 112b, respectively, network 112 may be a continuous network without departing from the scope of this disclosure, so long as at least portion of network 112 may facilitate communications between senders and recipients of queries 150 and results. In other words, network 112 encompasses any internal and/or external network, networks, sub-network, or combination thereof operable to facilitate communications between various computing components in database environment 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations.

Database environment 100 may also include one or more clients 104. Client 104 may be any local or remote computing device operable to receive requests from the user via a user interface 116, such as a GUI, a Command Line Interface (CLI), or any of numerous other user interfaces. Thus, where reference is made to a particular interface, it should be understood that any other user interface may be substituted in its place. In various embodiments, each client 104 includes at least GUI 116 and comprises an electronic computing device operable to receive, transmit, process and store any appropriate data associated with environment 100. It will be understood that there may be any number of clients 104 communicably coupled to server 102. Further, “client 104” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers to submit or review queries 150 via GUI 116. As used in this disclosure, client 104 is intended to encompass a personal computer, touch screen terminal, workstation, network computer, kiosk, wireless data port, wireless or wireline phone, personal data assistant (PDA), one or more processors within these or other devices, or any other suitable processing device. For example, client 104 may comprise a computer that includes an input device, such as a keypad, touch screen, mouse, or other device that can accept information, and an output device that conveys information associated with the operation of server 102 or clients 104, including digital data, visual information, or GUI 116. Both the input device and output device may include fixed or removable storage media such as a magnetic computer disk, CD-ROM, or other suitable media to both receive input from and provide output to users of clients 104 through the display, namely GUI 116.

GUI 116 may include a graphical user interface operable to allow the user of client 104 to interface with at least a portion of environment 100 for any suitable purpose. Generally, GUI 116 provides the user of client 104 with an efficient and user-friendly presentation of data provided by or communicated within environment 100. GUI 116 may provide access to the front-end of business application 130 executing on client 104 that is operable to add or modify data objects of data repository 145, or also to reorganize data repository 145. In some cases, GUI 116 may provide access to the front-end of business application 130 executing on client 104 that is operable to receive requests to archive active data objects 230 to archived data objects 240, as well as search active data objects 230 and/or search archived data objects 240, utilizing one or more archive indices 220. In a further example, GUI 116 may display output reports such as summary and detailed reports. GUI 116 may comprise a plurality of customizable frames or views having interactive fields, pull-down lists, and buttons operated by the user. In one embodiment, GUI 116 may present information associated with queries 150 and receive commands from the user of client 104 via one of the input devices. Moreover, it should be understood that the term graphical user interface may be used in the singular or in the plural to describe one or more graphical user interfaces and each of the displays of a particular graphical user interface. Therefore, GUI 116 contemplates any graphical user interface, such as a generic web browser or touch screen, that processes information in environment 100 and efficiently presents the results to the user.

FIG. 2 illustrates a more detailed configuration of the database system 200 of a database environment such as, for example, database environment 100. In general, database system 200 includes online data repository 145 and a database management system, and is communicably coupled to archive framework 140. Online data repository 145 may include one or more active data objects 230, each including one or more data elements 232. Active data objects 230 may be unstructured data objects such as, for example, business documents generated by or through a business process, e.g., invoices, sales orders, purchase orders, and the like. Online data repository 145 may also include one or more active indices 210 and archived indices 220. Active indices 210 may include metadata attributes corresponding to data stored on the active data objects 230. Thus, the active indices 210 may point to the online data repository 145. Archive indices 220 may include metadata attributes corresponding to metadata attributes 242 contained in archived data objects 240 and point to an offline data repository 155. For example, such indexed metadata attributes may include nodal attributes, and the like.

Archive framework 140 may also be communicably coupled to the offline data repository 155 and API 135. In some aspects, archive framework 140 may receive a request to archive one or more active data objects 230 through an exposed API 135 method such as, for example, through business application 130. The request from the exposed API 135 method may also include an identification of one or more archive indices 220. In some aspects, the exposed API 135 method may identify the archived indices 220 that have been previously generated and reside on online data repository 145, or in some cases, offline data repository 155. Further, in some aspects, the exposed API 135 method may identify one or more archived indices 220 by sending the indices 220 to the archive framework 140 through the archival request. Regardless of the identification method, as described above, each archive index 220 points to the offline data repository 155 and contains one or more metadata attributes associated with the active data objects 230 to be archived.

Continuing with FIG. 2, the archive framework 140 archives the one or more active data objects 230 into archived data objects 240. Concurrently, archive framework 140 may parse each archived data object 240 into one or more metadata attributes 242 according to the one or more metadata attribute criteria associated with the active data objects 230. This parsing may include scanning the active data objects 230, retrieving metadata from the active index or storage media (such as a path), as well as any other appropriate processing of the active data object 230, to determine or identify metadata. Moreover, archive framework 140 may populate the identified archive index 220 with the parsed metadata attributes 242. Thus, the archived data object 240 may be indexed according to the metadata attributes 242 contained within. After the active data objects 230 have been archived, archive framework 140 may remove the active data objects 230 from the online data repository 145. Further, archive framework 140 may remove index data associated with the active data objects 230 from the active index 210.

As an example, a request from the exposed API 135 method may include a request to archive all active data objects 230 which are document-type “invoice.” The request may further identify two archive indices 220 through the identification of metadata attribute criteria document-type “invoice” and date-generated “2004” for one, and date-generated “2005” for the other. During archival of the active data objects 230 into archived data objects, metadata attributes identifying the active data objects 230 as an “invoice” and generated in “2004” or “2005” are stored in the archived data objects 240 in offline data repository 155. The metadata attributes 242 are further populated into the appropriate archived indices 220, which point to the archived data objects 240. Upon a search for archived data objects 240 containing these metadata attributes 242 (performed subsequently to the archival process), the archival indices 220 can normally point to the corresponding archived data objects 240 for retrieval.

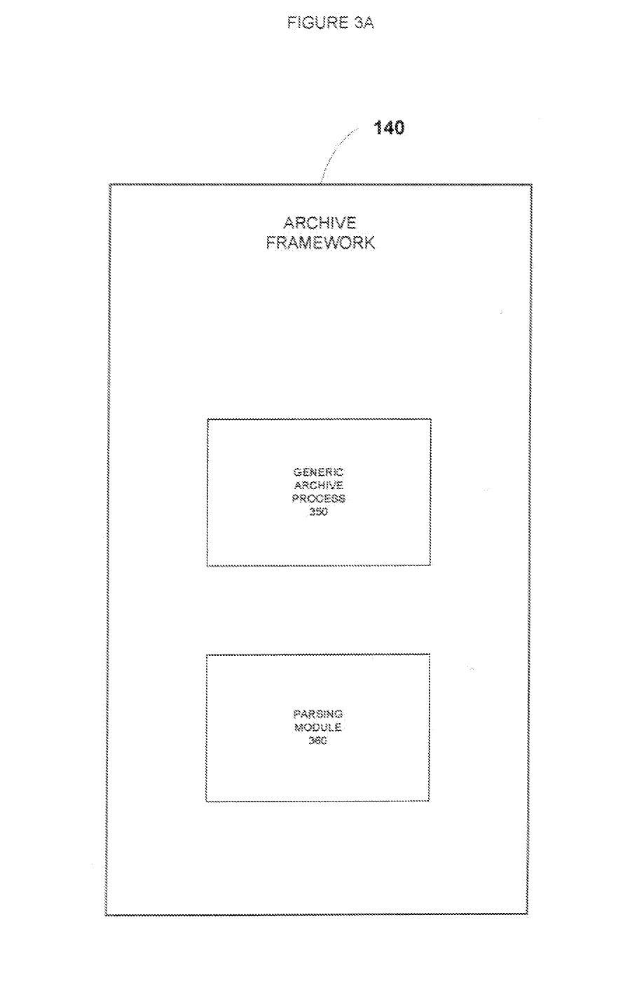

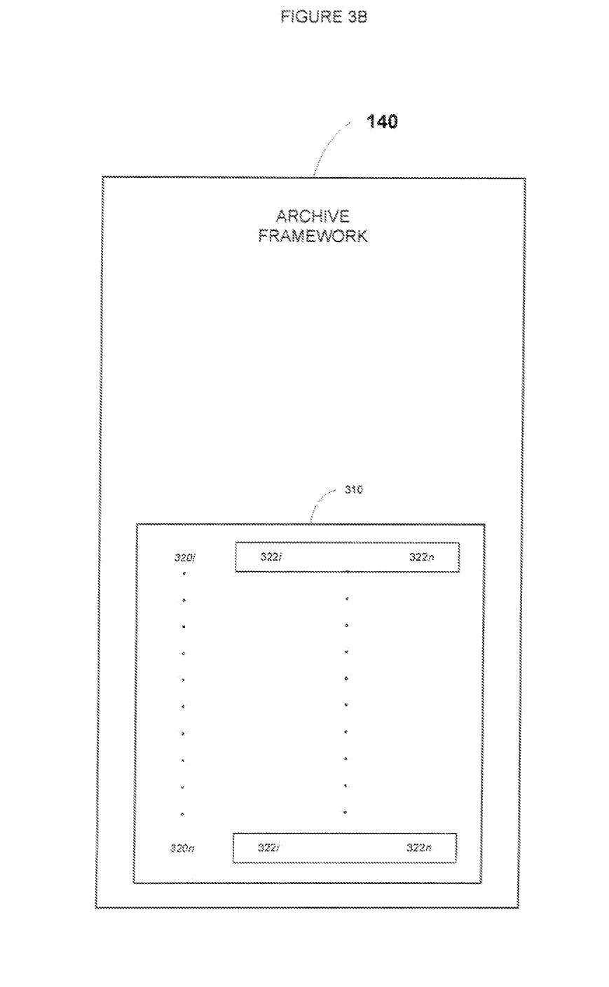

FIG. 3A illustrates another example of an archive framework in a database environment such as, for example database environment 100. Archive framework 140, as shown in FIG. 3A, may allow for the archival of active data objects 230 using a generic archive process 350. Archive framework 140 may also allow for the building of one or more archive indices 220 by scanning the archived data objects 240 in an offline data repository 155. For example, archive framework 140 may utilize generic archive process 350 to archive active data objects 230 from an online data repository 145 into archived data objects 240 stored in an offline data repository 155. Thus, client 104 may generate a query 150, e.g. an archival request, to archive framework 140 to archive one or more active data objects 230. In some cases, business application 130 may transmit an archival request to archive framework 140 to archive certain active data objects 230 based on specific characteristics of the data object 230 such as, for example, the date the active data object 230 was created. Once archive framework 140 receives the archival request, generic archive process 350 may archive the objects 230 utilizing an existing archive technique without concurrently building an archive index 220 based on metadata attributes 242 contained in archived data object 240. This may allow for quicker archival of one or more active data objects 230.

Continuing with FIG. 3A, once the active data objects 230 are archived, client 104 may choose to supplement (or build) archive index 220 based on metadata attributes 242 contained in the archived data objects 240 at any time. Business application 130 may also request archive framework 140 to build one or more archive indices 220 based on any number of events. For example, business application 130 may request the archive index 220 to be built after a specified time period, occurrence of a specified event in a particular business process run by client 104, or the archival of a specified threshold number of active data objects 230. Parsing module 360 may be applied by the archive framework 140 to parse the archive data object 240 in the offline data repository 155 into one or more metadata attributes 242. The archive framework 140 then may populate archive index 220 with the metadata attributes 242, thereby indexing the archived data object 240. In some implementations, archive index 220 is a generic archive index 220. If the generic archive index 220 has not been created, archive framework 140 may generate the generic archive index 220 so that it may be populated with the appropriate metadata attributes 242. Moreover, archive index 220 may be stored within online data repository 145 or offline data repository 155. In either case, however, archive index 220 may point to the parsed archived data objects 240 stored in offline data repository 155 based on the metadata attributes stored therein.

Often, the offline data repository 155 may contain more than one archived data object 240 and possibly even many hundreds or thousands. In these cases, client 104 or business application 130 may choose to build the archive index 220 from the multiple archived data objects 240 at the same or substantially same time. For example, parsing module 360 may execute a batch process that parses the multiple archived data objects 240 concurrently or consecutively. The metadata attributes 242 parsed from the archived data objects 240 may then be populated into one or more archived indices 220. However, whether one or multiple archived data objects 240 are parsed concurrently, this may not affect the archival process or subsequent search of the archived data objects 240.

FIG. 3B illustrates an example of an archive framework in a database environment such as, for example, database environment 100. Archive framework 140, as shown in FIG. 3B, may allow for the archival of active data objects 230 using a customization table 310, while simultaneously or substantially simultaneously populating one or more archive indices 220. Customization table 310 includes one or more table records 320, each table record 320 associated with one or more metadata attributes 322. Client 104 may request to archive one or more active data objects 230 utilizing a generic request method to archive framework 140. The request may be through query 150 from client 104, or may be generated automatically through a business application 130. Along with the request to archive the one or more active data objects 230, archive framework 140 may receive one or more metadata attribute criteria from client 104 or business application 130. For instance, the metadata attribute criteria may be a business document type such as, for example, a sales order, accounting document, invoice, purchase order, or other appropriate document generated by or through a business process. Archive framework 140 may compare the metadata attribute criteria with metadata attributes 322 within customization table 310 to identify corresponding metadata attributes 322. The corresponding metadata attributes 322 may be utilized to populate an archive index 220, thereby indexing the archived data object 240 stored in an offline data repository 155.

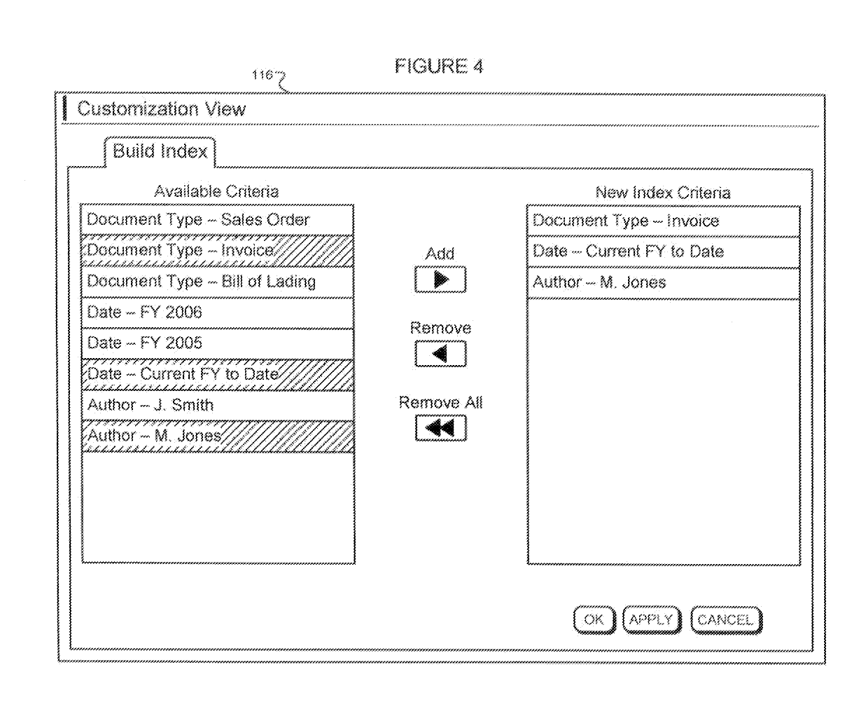

Archive framework 140 may also present the customization table 310 to client 104, so that (perhaps authenticated) client 104 may customize one or more archive indices 220. For example, client 104 may choose to add records to the customization table 310 based on one or more selected index criteria that correspond to metadata attributes 242 in archived data objects 240. As illustrated in FIG. 4, business application 130 may present a customization view to client 104 through GUI 116 in order for client 104 to customize one or more archive indices 220. Metadata attributes 322 may be presented as available index criteria in the customization view. Client 104 may choose one or more index criteria from the available criteria to define a particular archive index 220. When one or more active data objects 230 are archived, the particular archive index 220 may be populated with metadata attributes 242 contained in the archived data objects 240 according to the selected index criteria. For example, as shown in FIG. 4, client 104 may build a record in customization table 310 that includes three index criteria: “Document type—Invoice,” “Date—Current FY (Fiscal year) to date,” and “Author—M. Jones.” When the active data object 230 is to be archived, business application 130 may identify one of the records in customization table 310. Using this record, the archive framework 140 may archive the data objects 130 into an archived data object 240 stored in the offline data repository 155, with the particular archive index 220 pointer potentially defined by these criteria populated with one or more metadata attributes 242. Thus, any search of archived data objects 240 based upon these criteria may return archived data objects 240 containing these particular metadata attributes 242.

In some aspects, access to particular index criteria may be controlled by the archive framework 140. For example, a developer of business application 130 may define several levels of access permission to the customization table 310. Each level of access permission may allow a client 104 to access different metadata attributes 322 in order to define archive indices 220. Further, access permission levels may be used to control access to an archive index 220 already defined, e.g., only particular clients 104 may adjust or modify an existing archive index 220.

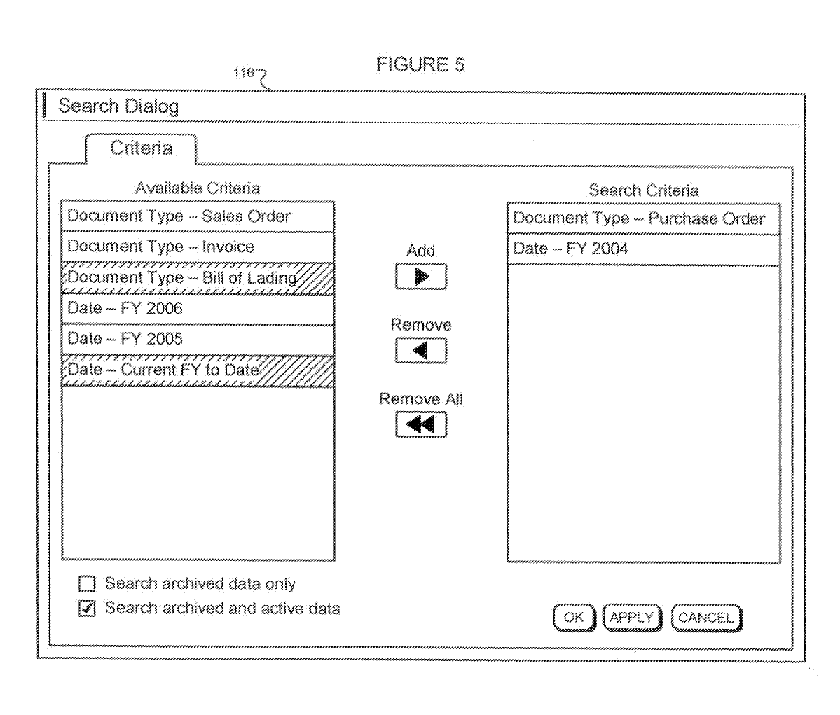

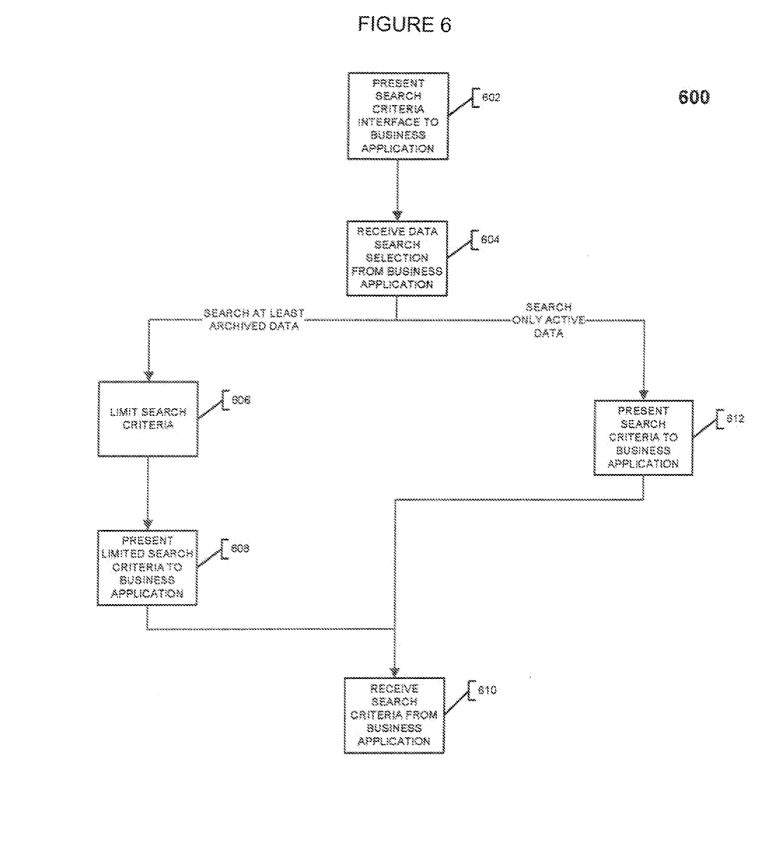

FIG. 6 is a flowchart illustrating an addition of search criteria to a search of archived data and/or active data through GUI 116 in a database environment such as, for example, database environment 100. GUI 116 may present an interface for adding search criteria, corresponding to metadata attributes 322, to a search of archived data objects 240 and/or active data objects 230 in a same or substantially similar viewpoint as illustrated in FIG. 5. In step 602, archive framework 140 presents a search criteria interface to business application 130 for viewing by client 104 on GUI 116. As illustrated in FIG. 5, the interface presents the available search criteria to client 104. In step 604, the archive framework 140 receives a data search selection from the business application 130. For example, the search criteria interface may allow client 104 to specify the breadth of data to be searched. As shown in FIG. 5, client 104 may choose to search archived data objects 240 stored in an offline data repository 155 and active data objects 230 stored in an online data repository 230 by selecting the appropriate box. Client 104 may also choose to only search archived data objects 230 stored in the offline data repository 155 by selecting the appropriate box. Active data objects 230 may be searched exclusively if, for example, the client 104 does not select either box.

Continuing with FIG. 6, if client 104 chooses to search at least archived data objects 240, i.e., selects either appropriate box as illustrated in FIG. 5, then the archive framework 140 may limit the available criteria in the search criteria interface, as shown in step 606. For instance, the metadata attributes 322 contained within the archived data objects 240 and archive index 220 may only be a subset of metadata attributes contained in an active index 210. The available criteria may then be limited to those metadata attributes 322 contained within the archive index 220. Those attributes contained within the active index 210, but not the archive index 220, may be unavailable for selection by the client 104 should the search include archived data objects 240. As one example, FIG. 5 illustrates that two search criteria are unavailable for selection for a search including archived data objects 240: “Document type—Bill of Lading” and “Date - Current FY (Fiscal Year) to date.” In step 608, the archive framework 140 presents a viewable portion of the limited search criteria to the business application 130 through the search criteria interface of GUI 116 as shown in FIG. 5.

Based on these presented criteria, the archive framework 140 receives the selected search criteria from client 104 through business application 130. For example, as shown in FIG. 5, the selected search criteria are “Document type—Purchase Order” and “Date—FY (Fiscal Year) 2004.” Once selected, these particular search criteria are removed from the list of available criteria, however, client 104 may choose to change the selected search criteria once chosen by removing them to the list of available criteria. Continuing with FIG. 6, if client 104 chooses to search only active data objects 230, the archive framework 140 may present the full set of search criteria as contained in the active index 210 to the client 104 for selection, as shown in step 612. Archive framework 140 may then receive the search criteria selected by client 104 through business application 130 in step 610.

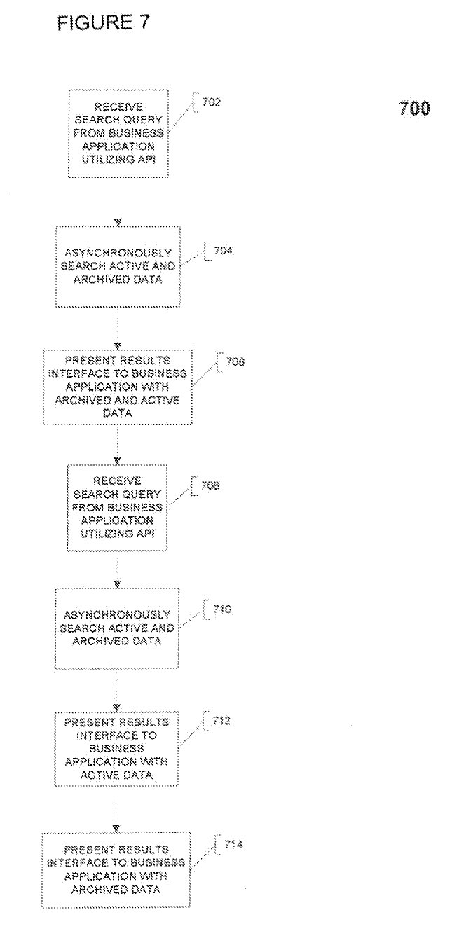

FIG. 7 is a flowchart illustrating a search of archived data and active data in a storage environment such as, for example, database environment 100. In step 702, archive framework 140 receives a search query from business application 130, perhaps utilizing an application program interface (API) 135. The search query may be query 150 from client 104 through the front-end of business application 130. The search query, however, may also be an automatic query originated by business application 130 as part of the functionality of the business application 130 developed by the client 104, another modeler, developer, or user, or as pre-set functionality. In step 704, archive framework 140 asynchronously searches active data objects 230 and archived data objects 240. For example, archive framework 140 may compare selected search criteria to an archive index key contained in an archive index 220 and attributes contained in an active index 210, in order to locate archived data objects 240 and active data objects 230 with the selected search criteria, respectively. In step 706, the archive framework 140 may present a results interface to a business application 130 with the archived data objects 240 and active data objects 230, such that the results of the online and offline search are merged. In some embodiments, the results interface may be displayed together in a scrolling, i.e., expanding panel or window. Further, retrieved archived data objects 240 may be displayed in the application from which it originally was generated. In some aspects, the archived data objects 240 and active data objects 230 returned from the search may be graphically distinct, e.g., color-coded.

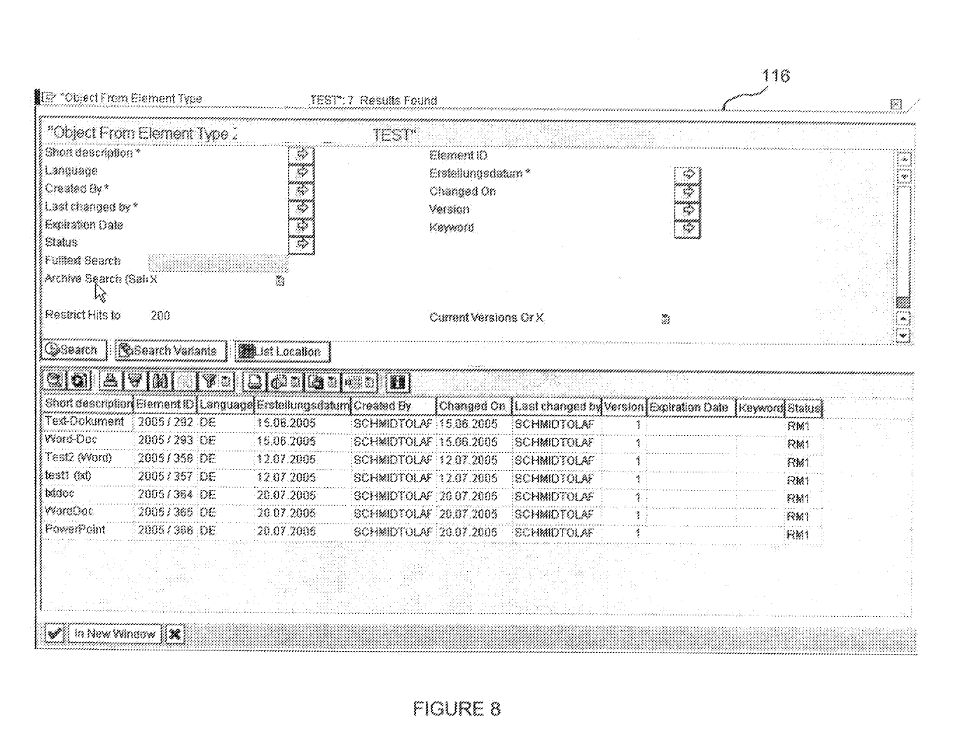

Continuing with FIG. 7, in step 708, archive framework 140 may receive a second search query from business application 130 through the API 135. In some cases, the second search query may be from a distinct business application 130 from that which the first search query was received. Further, in some instances, the second search query may be a query 150 generated by client 104. Client 104 may be the same client 104 that originated the first search query or may be a distinct client 104. In sum, the second search query may be generated by or originated from any number of clients 104 and/or business applications 130. In step 710, archive framework 140 asynchronously searches active data objects 230 and archived data objects 240 located on online data repository 145 and offline data repository 155, respectively. In step 712, the archive framework 140 presents the results interface to the business application 130 with the active data objects 230, which may, in some cases, be returned through the search before the archived data objects 240 are returned from the offline data repository 155. Thus, client 104 may receive the search results with the active data objects 230 prior to the search returning the archived data objects 240. In step 714, archive framework 140 presents the results interface to the business application 130 with the returned archived data objects 240, perhaps via GUI 116 illustrated in FIG. 8. In this example interface 116, the archiving framework 140 may also retrieve the content of an archived document from the archive and transfer it to the original application 130. To do this, the framework offers the interface 116, which can be utilized by various disparate applications. For example FIG. 8 illustrates GUI 116 that includes attributes marked with an *, which are part of an archive-index and can be used for an archive search. Once the search-operation is executed and (at least a portion of) the result list presented to the client 104, the user can perform a double-click or other action on an entry in the list. In response to the particular action, the content of the corresponding document is retrieved from the archive and is displayed in the corresponding application. Moreover, when the particular action is executed on an entry in the result-list, the corresponding application can be automatically opened or started with the respective object or document (such as a word processing application, spreadsheet, presentation, text reader, and so forth).

The preceding flowcharts and accompanying description illustrate example methods. Database environment 100 contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, database environment 100 may use methods with additional steps, fewer steps, and/or different steps, so long as the methods remain appropriate. In short, although this disclosure has been described in terms of certain embodiments and generally associated methods, alterations and permutations of these embodiments and methods will be apparent to those skilled in the art. Accordingly, the above description of example embodiments does not define or constrain the disclosure. Other changes, substitutions, and alterations are also possible without departing from the spirit and scope of this disclosure, and such changes, substitutions, and alterations may be included within the scope of the claims included herewith.

What is claimed is:

1. Software for archiving data, the software comprising computer readable instructions embodied on media and operable when executed to:
receive a request to archive an unstructured data object; and
archive the unstructured data object into an archive object in an offline storage media, the archive object associated with one or more metadata attributes.

2. The software of claim 1, the request received from an exposed application programming interface (API) method embedded within a communicably coupled business application.

3. The software of claim 2, the software receiving identification of an archive index via the request from the exposed API, wherein:
the archive index points to the offline storage media and is based on one or more metadata attribute criteria; and
the software operable to archive comprises software operable to:
parse the archive object into one or more metadata attributes according to at least a subset of the attribute criteria; and
populate the archive index with the one or more metadata attributes indexing the archive object.

4. The software of claim 1, the request comprising an invoked generic method associated with an attribute table.

5. The software of claim 4, wherein the software operable to archive comprises software operable to:
receive at least one attribute identifier from the requestor;
identify one or more metadata attributes based on the attribute table and the attribute identifier; and
populate an archive index with the one or more metadata attributes indexing the archive object.

6. The software of claim 4 further operable to present the table to a client for customization.

7. The software of claim 6 further operable to control access to the table based on an access permission level.

8. The software of claim 1, wherein the software operable to archive comprises software operable to:
execute a generic archive process to archive the unstructured data object in the offline storage media;
parse the archive object in the offline storage media into one or more metadata attributes; and
populate a generic archive index with the one or more metadata attributes indexing the archive object, the generic archive index pointing to the offline storage media and based on one or more metadata attribute criteria.

9. The software of claim 8 further operable, if the generic archive index does not exist, to generate the generic archive index.

10. The software of claim 8, wherein the software operable to parse comprises software operable to execute a batch process that parses a plurality of archive objects in the offline storage media into one or more respective metadata attributes.

11. The software of claim 1 further operable to drop the unstructured data object from an online storage media.

12. The software of claim 1, each archive index comprising at least one metadata attribute and at least one index key utilizing one of the metadata attributes.

13. The software of claim 12 further operable to access the archive object in the offline storage media utilizing the index key.

14. The software of claim 1, the archive index stored in a disparate storage device from the offline storage media.

15. A system for archiving data, comprising:
means for receiving a request to archive an unstructured data object; and
means for archiving the unstructured data object into an archive object in an offline storage media, the archive object associated with one or more metadata attributes.

16. The system of claim 15, the request received from an exposed application programming interface (API) method embedded within a communicably coupled business application.

17. The system of claim 16 further comprising means for receiving identification of an archive index via the request from the exposed API, wherein:
the archive index points to the offline storage media and is based on one or more metadata attribute criteria; and
the system further comprising:
means for parsing the archive object into one or more metadata attributes according to at least a subset of the attribute criteria; and
means for populating the archive index with the one or more metadata attributes indexing the archive object.

18. The system of claim 15, the request comprising an invoked generic method associated with an attribute table.

19. The system of claim 18 further comprising:
means for receiving at least one attribute identifier from the requestor;
means for identifying one or more metadata attributes based on the attribute table and the attribute identifier; and
means for populating the archive index with the one or more metadata attributes indexing the archive object.

20. The system of claim 18 further comprising means for presenting the table to a client for customization.

21. The system of claim 20 further comprising means for controlling access to the table based on an access permission level.

22. The system of claim 15 further comprising:
means for executing a generic archive process to archive the unstructured data object in the offline storage media;
means for parsing the archive object in the offline storage media into one or more metadata attributes; and
means for populating a generic archive index with the one or more metadata attributes indexing the archive object, the generic archive index pointing to the offline storage media and based on one or more metadata attribute criteria.

23. The system of claim 22 further comprising, if the generic archive index does not exist, means for generating the generic archive index.

24. The system of claim 15 further comprising means for dropping the unstructured data object from an online storage media.

25. A computer-implemented method for managing archived data, comprising:
receiving a first query from a first application instance utilizing an application programming interface (API);
based on the first query, asynchronously searching active data and archived data using an archive index that identifies at least a portion of metadata when the archived data was active;
presenting a first results interface to the first application that displays results as they are received from the query executions;
receiving a second query from a second application instance utilizing the API;
based on the second query, asynchronously searching active data and archived data using an archive index; and
presenting a second results interface to the second application that displays results as they are received from the query executions.

26. The method of claim 25 further comprising:
presenting a search criteria interface to the first application, the search criteria interface comprising a plurality of search criteria; and
receiving at least one search criteria from the first application, the search criteria comprising one or more of a plurality of metadata attributes.

27. The method of claim 26, the first and second queries comprising at least one of the plurality of search criteria.

28. The method of claim 26, the one or more metadata attributes corresponding to the portion of metadata identified when the archived data was active.

29. The method of claim 26 further comprising receiving a data search selection from the first application, the data search selection comprising the active data and the archived data.

30. The method of claim 29 further comprising limiting the plurality of search criteria based on the data selection.

31. The method of claim 25, the searching of the archived data utilizing an index key, the index key stored in the archive index.

32. A system for managing archived data, comprising:
at least one memory, the memory storing:
active data;
archived data; and
an application programming interface (API); and
one or more processors operable to execute the API such that the API:
receives at least one query from the client;
based on the query, asynchronously searches the active data and the archived data using an archive index that identifies at least a portion of metadata when the archived data was active; and
presents a results interface to the client that displays the results as they are received from the query executions.

33. The system of claim 32, the API further operable when executed to:
present a search criteria interface to the first application, the search criteria interface comprising a plurality of search criteria; and
receive at least one search criteria from the first application, the search criteria comprising one or more of a plurality of metadata attributes.

34. The system of claim 33, the query comprising at least one of the plurality of search criteria.

35. The system of claim 34, the one ore more metadata attributes corresponding to the portion of metadata identified when the archived data was active.

36. The system of claim 33, the API further operable to receive a data selection from the first application, the data selection comprising the active data and the archived data.

37. The system of claim 36, the API further operable to limit the plurality of search criteria based on the data selection.
